(19) United States
(12) Patent Application Publication
(10) Pub. No.: US 2021/0394524 A1
(43) Pub. Date: Dec. 23, 2021

(54) DISPLACEMENT PUMP

(71) Applicant: Hewlett-Packard Development Company, L.P., Spring, TX (US)

(72) Inventors: Yinon Harari, Ness Ziona (IL); Alexander Yekymov, Ness Ziona (IL); Ziv Seemann, Ness Ziona (IL)

(73) Assignee: Hewlett-Packard Development Company, L.P., Spring, TX (US)

(21) Appl. No.: 17/289,762

(22) PCT Filed: Dec. 11, 2018
(86) PCT No.: PCT/US2018/064937

§ 371 Date: Apr. 29, 2021

(51) Int. Cl. B41J 2/175; F04B 5/00; F04B 15/00

(52) U.S. Cl. CPC B41J 2/17596; F04B 15/00; F04B 5/00

(57) ABSTRACT

In certain examples, a printing system comprises: a depositing system to deposit printing fluid on a print medium; a reservoir; and a displacement pump to move printing fluid to the depositing system from the reservoir. The displacement pump comprises: a pump body defining a chamber, an inlet to fluidly connect the chamber to the reservoir, and an outlet to fluidly connect the chamber to the depositing system; and a displacement member movable relative to the pump body; the displacement member having an outer surface and comprising a cavity located in a portion of the outer surface disposed in the chamber. In use, the displacement member is movable to close the inlet and to force printing fluid in the chamber through the outlet to the depositing system.

### BACKGROUND

In certain printing systems, printing fluid is delivered from a reservoir to a depositing system, which deposits the printing fluid on a print medium to produce an image. In some systems, a displacement pump may be used to move the printing fluid from the reservoir to the depositing system.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an example printing system comprising a displacement pump.

FIG. 2 is a graphical projection of a cross section through an example displacement pump.

FIG. 3 is a graphical projection of a cross section through an example displacement pump.

FIG. 4 is a graphical projection of a cross section through an example displacement pump.

FIG. 5 is a cross section through the example displacement pump of FIG. 4.

### DETAILED DESCRIPTION

In certain printing operations, a printing fluid may be used in the production of graphical images on a print medium. The printing fluid may contain pigments and/or dyes with which the image is formed on print medium. For example, the printing fluid may contain carbon black with which an image is formed on a print medium. The printing fluid may comprise a carrier fluid in which the pigment and/or dyes are suspended during transport to the print medium.

In some printing operations, the printing fluid used may have a relatively high viscosity. In some examples, the printing fluid may resemble a thick paste. For example, the printing fluid may have a significantly higher viscosity than water at 20° Celsius.

Displacement pumps can be used to move fluids. In one example, a reciprocating member, such as a piston or a plunger, can be used to move fluids in pulses. Displacement pumps can be used to move printing fluids, for example in a printing system.

In certain examples, displacement pumps can be used to move fluids with a relatively high viscosity, for example, oils or foodstuffs such as liquid sugars. In some cases, displacement pumps can be used to move printing fluids with a relatively high viscosity, such as the printing fluids described above.

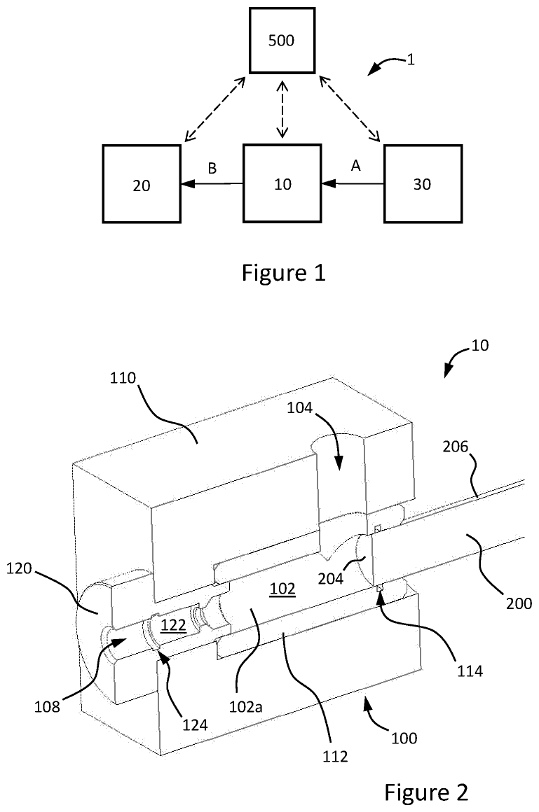

FIG. 1 is a block diagram of a printing system 1 comprising a displacement pump 10 that is connected to a depositing system 20 and is connected to a reservoir 30. In use, the displacement pump 10 moves printing fluid from the reservoir 30 the depositing system 20. The printing system 1 may be, for example, a large printing press. The reservoir 30 may be, for example, a printing fluid cartridge that stores the printing fluid for use in the depositing system 20.

During operation of the printing system 1, the printing fluid may move from the reservoir 30, in the direction of arrow A, to the displacement pump 10. The printing fluid may be drawn from the reservoir 30 by the displacement pump 10. In some examples, the printing fluid may be kept under pressure so as to drive the printing fluid towards the displacement pump 10.

During operation of the printing system 1, the printing fluid may move from the displacement pump 10, in the direction of arrow B, to the depositing system 20. Once delivered to the depositing system 20, the delivered printing fluid may be deposited on a print medium by the depositing system 20. For example, the depositing system 20 may comprise a plurality of print nozzles through which the printing fluid may be ejected onto the print medium.

FIG. 2 shows a perspective view of a cross section through an example of a displacement pump 10. The displacement pump 10 may be used to move a fluid. For example, the fluid may be a printing fluid. The displacement pump 10 may be used in the printing system 1 shown in FIG. 1 to move printing fluid from the reservoir 30 to the depositing system 20.

The displacement pump 10 comprises a pump body 100 defining a chamber 102. The chamber 102 may have a volume. The pump body 100 may comprise an inlet 104. The inlet 104 may be to fluidly connect the chamber 102 to the reservoir 30. The pump body 100 may comprise an outlet 108. The outlet 108 may be to fluidly connect the chamber 102 to the depositing system 20.

The displacement pump 10 comprises a displacement member 200. The displacement member 200 is movable relative to the pump body 100. The displacement member 200 may have an outer surface 202, a portion of which may be located in the chamber 102 when the displacement member 200 is assembled with the pump body 100. The portion of the surface 202 that is located in the chamber 102 may increase or decrease depending of the position of the displacement member 200 relative to the pump body 100.

In use, fluid may be delivered through the inlet 104 into the chamber 102. As can be seen from FIG. 2 the inlet 104 may be open when the displacement member 200 is in a starting, or retracted, position so as to allow fluid to be admitted into the chamber 102. The displacement member 200 may be movable to force fluid in the chamber through the outlet 108. The displacement member 200 may move forward to reduce the volume of the chamber 102. The forward motion of the displacement member 200 may shut the inlet 104 off from chamber 102 hand thereby trapping the volume of fluid in the chamber 102. By moving further forward the volume of fluid may be displaced through the outlet 108. Once the displacement member 200 has completed a full stroke and reached its end position, the displacement member 200 may then be retracted to its starting position in order to open the inlet 104 and admit a new volume of fluid into the chamber 102.

In certain examples, the displacement member 200 may have a circular profile and be generally cylindrical in shape. For example, the outer surface 202 of the displacement member 200 may comprise a cylindrical surface 206. In such cases, the chamber 102 may comprise a cylindrical surface 102a that compliments the cylindrical surface 206 when the placement member 200 is slidingly fitted to the pump body 100. In certain examples, the outer surface 202 of the displacement member 200 may comprise an end face 204. The end face 204 may act to transmit force to the volume of printing fluid as the displacement member 200 moves forward to displace the printing fluid from the chamber 102. In some examples, the end face 204 may be perpendicular to an axis the cylindrical surface 206.

The pump body 100 may comprise a single component or comprise a plurality of components. For example, as shown in FIG. 2, the pump body 100 may comprise a pump chassis 110 onto which other components that define features of the pump body 100 are assembled. In certain examples, the chamber 102 may be defined by a sleeve 112 that fits into the pump chassis 110. In some cases, where the displacement member 200 comprises a cylindrical surface 206, the sleeve 112 may define the cylindrical surface 102a that slidingly mates with the cylindrical surface 206. In some examples, the sleeve 112 may comprise a seal groove 114 into which a seal, such as a resilient O-ring for example, may be mounted to seal between the chamber 102 and the displacement member 200.

In certain examples, the outlet 108 of the pump body 100 may comprise an outlet valve block 120. The outlet valve block 120 may be mounted to the pump chassis 110. For example, the outlet valve block 120 may have a generally cylindrical shape and be received in a complementarity shaped hole in the pump chassis 110. The outlet valve block 120 may define an outlet passage 122 through which fluid may be expelled from the chamber 102 by the motion of the displacement member 200. In certain examples, the outlet passage 122 may fluidly connect the chamber 102 with a fluid conduit that leads to the depositing system 20.

The outlet 108 of the pump body 100 may comprise a one-way valve that prevents expelled fluid from returning to the chamber 102 when the displacement member 200 is retracted to its starting position. A mounting feature 124 for the one-way valve may, for example, be provided on the valve block 122.

Although not shown in FIG. 2, the inlet 104 of the pump body 100 may, in certain examples, comprise an inlet valve block. The inlet valve block may be mounted on the pump chassis 110. In some examples, the inlet 104 of the pump body 100 may comprise a one-way valve that prevents printing fluid that has been admitted to the chamber 102 from travelling back through the inlet 104 from the chamber 102.

In certain examples, the inlet 104 may not have a one-way valve. For example, where the displacement pump 10 handles a fluid with a relatively high viscosity, a one-way valve located in the inlet 104 may be dispensed with.

In certain examples, the fluid to be delivered to the chamber 102 may be kept at high enough pressure that the fluid is forced into the chamber 102 when the displacement member 200 is in its starting position and the inlet 104 is open.

In some cases, fluid located in the inlet 104 of the pump body 100 may be subjected to a pressure rise as the displacement member 200 begins to move to force fluid in the chamber 102 out through the outlet 108. Such pressure rises may continue in the fluid located in the inlet 104 until the displacement member 200 moves far enough along its stroke to shut the inlet 104. In some examples, where the inlet 104 comprises a one-way valve, the pressure rise in the inlet 104 may be even higher when the displacement member 200 begins to move due to the presence of the one-way valve.

The pressure rises in the inlet 104 may cause damage to the components of the inlet 104 for example, pressure fluctuations in the inlet 104 may cause damage to conduit tubing through which fluid is delivered to the chamber 102. For instance, the pressure fluctuations in the inlet 104 may cause fatigue in inlet 104 components. Furthermore, the pressure rise resulting from the displacement member 200 beginning to move can force fluid from the chamber 102 back through the inlet 104. Pushing fluid back through the inlet 104 may be undesirable since the whole volume of fluid delivered to the chamber 102 is not forced through the outlet 108 and this reduces the effectiveness of the displacement pump 10. In some examples, pressure rises in the inlet 104 may cause damage to the reservoir 30 and its components. For example, pressure rises in the inlet 104 may damage a printing fluid cartridge and/or the delivery tubing from which the printing fluid is delivered to the chamber 102. In some examples where the inlet 104 comprises a one-way valve, the pressure rise in the inlet 104 can further damage the reservoir 30, such as the printing fluid cartridge and/or the delivery tubing, so that it is desirable to not use a one-way valve in the inlet 104.

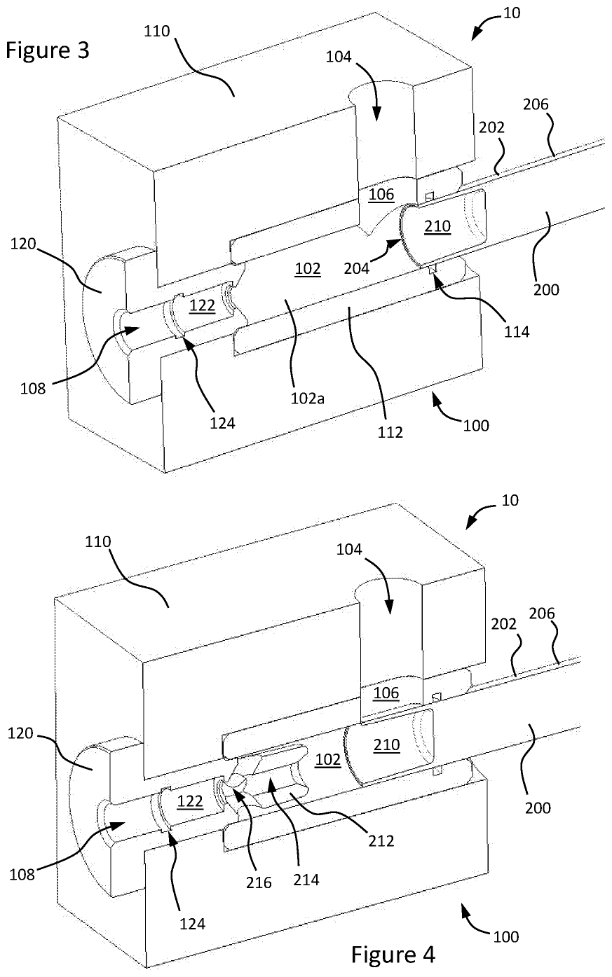

FIG. 3 shows a perspective view of a cross section through an example of a displacement pump 10. The displacement pump 10 may comprise one or more similar features to the displacement pump 10 described with respect to FIG. 2; similar features are indicated with like-numbered reference signs. The displacement pump 10 may be used to move a fluid. For example, the fluid may be a printing fluid. The displacement pump 10 of FIG. 3 may, for example, be used in the printing system 1 shown in FIG. 1 to move printing fluid from the reservoir 30 to the depositing system 20.

The displacement pump 10 comprises a pump body 100 defining a chamber 102. The chamber 102 has a volume. The pump body 100 may comprise an inlet 104. The inlet 104 may be a fluid inlet that is in fluid communication with the chamber 102. The inlet 104 may comprise an opening 106 into the chamber 102. In certain examples, the inlet 104 may be to fluidly connect the chamber 102 to the reservoir 30. The pump body 100 may comprise an outlet 108. The outlet 108 may be a fluid outlet that is in fluid communication with the chamber 102. In certain examples, the outlet 108 may to fluidly connect the chamber 102 to the depositing system 20.

The displacement pump 10 comprises a displacement member 200. The displacement member 200 is movable relative to the pump body 100. The displacement member 200 may have an outer surface 202. A portion of the outer surface 202 may be disposed in the chamber 102. For example, the portion of the outer surface 202 may be disposed in the chamber 102 when the displacement member 200 is assembled with the pump body 100. The portion of the surface 202 that is located in the chamber 102 may increase or decrease depending of the position of the displacement member 200 relative to the pump body 100.

The displacement member 200 is movable, in use, relative to the pump body, to reduce the volume of the chamber 102. Moving the displacement member 200 forces fluid in the chamber 102 out through the fluid outlet. In certain examples, the displacement member 200 is movable, in use, relative to the pump body 100, to force fluid in the chamber 102 through the outlet 108 to the depositing system 20.

In certain examples, the displacement member 200 is movable, in use, relative to the pump body 100, to close the inlet 104. For example, as the displacement member 200 moves, it may slide across the opening 106 of the inlet 104 into the chamber 102. The action of closing the inlet 104 may be gradual in that the open portion of the opening 106 into the chamber 102 is gradually reduced.

The displacement member 200 is movable, in use, relative to the pump body, to increase the volume of the chamber 102. Moving the displacement member 200 may reduce the pressure in the chamber 102 as the volume increased. Moving the displacement member 200 to increase the volume of the chamber 102 allows a new volume of fluid to be admitted into the chamber 102 through the fluid inlet. For instance, moving the displacement member 200 to increase the volume of the chamber 102 may draw a vacuum, or cause a suction, that encourages the fluid to be drawn into the chamber 102. In certain examples, the displacement member 200 is movable, in use, relative to the pump body 100, to allow a new volume of fluid to be admitted into the chamber 102 through the inlet 104 from the reservoir 30.

In certain examples, the displacement member 200 is movable, in use, relative to the pump body 100, to open the inlet 104. For example, as the displacement member 200 moves, it may slide back across the opening of the inlet 104 into the chamber 102. The action of opening the inlet 104 may be gradual in that the open portion of the opening 106 into the chamber 102 is gradually increased.

The displacement member 200 is movable, in use, from a first position to a second position, relative to the pump body 100. Movement from the first position to the second position may reduce the volume of the chamber 102 to force fluid in the chamber 102 through the fluid outlet. For example, the first position may be considered a starting position and the second position may be considered an end position, relative to the pump body 100. Movement of the displacement member 200 from the first position to the second position may be described as the displacement stroke of the displacement pump 10. Movement of the displacement member 200 from the second position to the first position may be described as the intake stroke of the displacement pump 10. The intake stroke may also be described as the back stroke of the displacement pump 10. The displacement pump 10 may be described as a reciprocating displacement pump since the displacement member 200 may be repeatedly moved, from the first position to the second position and back to the first position, in order to repeatedly displace volumes of fluid from the chamber 102.

In certain examples, the displacement member 200 is movable, in use, from the first position, in which the fluid inlet is open to allow fluid to flow into the chamber 102, to the second position, where the fluid inlet is closed by the displacement member and the fluid in the chamber has been forced through the fluid outlet.

In certain examples, the displacement member 200 is movable, in use, from the second position, in which the fluid inlet is closed by the displacement member 200, to the first position where the fluid inlet is open to allow fluid to flow into the chamber 102.

FIG. 3 shows the example displacement pump 10 in which the displacement member 200 is in the starting position, or first position, before beginning the displacement stroke. FIG. 3 also shows that, in this example, the opening 106 of the inlet 104 is completely open when the displacement member is in the starting position.

The displacement member 200 comprises a cavity 210 located in the portion of the outer surface 202 disposed in the chamber 102. The cavity 210 may be, for example, described as a recess, a depression, or a hole that is located in the portion of the outer surface 202 disposed in the chamber 102.

The cavity 210 allows a volume of fluid to be accommodated in the displacement member 200. Thus, when the displacement member 200 is assembled with the pump body 100, an additional volume is available to accommodate fluid when the inlet 104 is open to the chamber 102.

It has been found that the cavity 210 allows a reduction of the pressure at the inlet 104, when the displacement member 200 is moved from the first position, in which the fluid inlet is open to allow fluid to flow into the chamber 102, to the second position, where the fluid inlet is closed by the displacement member, which may be detrimental to the performance of a displacement pump as described above. Without wishing to be bound by theory, it is believed that the cavity 210 allows an initial pressure rise in the fluid, resulting from the displacement member 200 beginning to move to force the fluid through the fluid outlet from the chamber 102, to be reduced. The cavity 210 provides an additional volumetric capacity as the displacement member 200 begins to move such that the fluid is not immediately pressurized by the displacement member 200. In effect, the inlet 104 is closed ‘earlier’ than with a displacement member that does not comprise the cavity 210. In other words, the inlet 104 is closed before the fluid is placed under pressure by the displacement member 200. This has the effect of reducing the damage caused by increased pressure in the inlet 104, as described above. Furthermore, the cavity 210 also has been found to reduce the amount of fluid flowing back through the fluid inlet as the displacement member 200 begins to move to force the fluid from the chamber 102 through the fluid outlet. The pressure variations generated by the act of closing the inlet 104 with the displacement member 200 can be reduced. This reduces the damage to the inlet 104 components, such as conduit tubing, and also reduces the loss of fluid back through the fluid inlet thereby increasing the efficiency of the displacement pump 10.

In some examples, in use and when the inlet 104 is open to the chamber 102, fluid may be admitted to the chamber 102 thereby filling the chamber 102 and, in some examples, a portion of the cavity 210 of the displacement member 200.

In certain examples, in use and when the inlet 104 is open to the chamber 102, and where the fluid is relatively viscous, fluid may be admitted to the chamber 102 but will not substantially flow into the cavity 210. It has been found that, in such circumstances, the presence of the cavity 210 in the outer surface 202 of the displacement member 200 is particularly beneficial in reducing the increase in pressure in the inlet 104 as the displacement member begins to move during the displacement stroke and to close the inlet 104. As the displacement member 200 begins to move to reduce the volume of the chamber 102 and force the fluid through the outlet 108, the fluid initially, at least partially, flows into the cavity 210 of the displacement member 200, rather than being subjected to an increase in pressure that would drive the fluid through the outlet 108. Thus, during the forward motion of the displacement member 200 the pressure of the fluid in the chamber 102 does not increase until the cavity 210 is entirely filled with fluid. In some examples, the geometry of the cavity 210 can be arranged to prevent a pressure rise in the fluid in the chamber 102 until the inlet 104 has been completely closed by the displacement member 200.

It has been observed by the Applicant that, in comparison with other displacement pumps, up to a 33% decrease in backflow of fluid through the inlet 104 occurs with the use of the example displacement pump 10 shown in FIG. 3. The reduction in the pressure at the inlet 104 as the displacement member 200 begins to move to perform the displacement stroke may have several benefits. Because less fluid may flow back through the inlet 104, more fluid may be expelled through the outlet 108 on every displacement stroke of the displacement member 200. Hence, the displacement pump 10 may be more efficient. It has been found by the Applicant that up to an 11% increase in fluid, per displacement stroke, may be displaced by the displacement pump 10. Hence, the displacement pump 10 may need fewer displacement strokes to deliver the acquired amount of fluid. For example, the displacement pump 10 in a printing system may need fewer displacement strokes to deliver a predetermined amount of printing fluid to the depositing system 20 thereby allowing, for instance, the printing system 1 to operate in a more efficient and/or faster manner.

The reduction in the pressure at the inlet 104 as the displacement member 200 begins to move to perform the displacement stroke may have the operating parameters of the displacement pump 10 to be improved. For example, a more viscous fluid may be dispensed by the displacement pump 10. For instance, a more viscous printing fluid may be delivered by the displacement pump 10. Or, for example, a higher portion of pigment and/or dye may be included in a printing fluid delivered by the displacement pump 10. For example, a larger percentage of carbon black may be carried by the printing fluid through the displacement pump 10.

In certain examples, the cavity 210 may comprise a recess, the recess having a mouth and a cross-sectional area of the recess that reduces with distance from the mouth. In certain examples, the cavity 210 may comprise a conical recess. In examples, the displacement member 200 may comprise a conical recess located in the portion of the outer surface 202 disposed in the chamber 102. In some examples, such as the case of the displacement pump 10 shown in FIG. 3, the conical recess is a truncated conical recess that substantially takes the form of a truncated cone. In other examples, the cavity 210 may be any suitable shape. In an example, the cavity 210 may be a cylindrical hole in the outer surface 202 of the displacement member 200. For example, the cavity 210 may be a cup shaped depression in the outer surface 202 of the displacement member 200.

In certain examples, a plurality of cavities 210 may be provided in the portion of the outer surface 210 of the displacement member 200 disposed in the chamber 102.

The displacement member 200 may take have any suitable shape. For example, the displacement member may be an elongate member. The elongate member may, for example, have a circular profile such that the elongate member is cylindrical. In other examples, the elongate member may have a rectangular, elliptical, hexagonal, or any other suitably shaped profile.

The displacement member 200 shown in FIG. 3 may, in an example, be generally cylindrical in shape. For example, the outer surface 202 of the displacement member 200 may comprise a cylindrical surface 206. In such cases, the chamber 102 may comprise a cylindrical surface 102a that compliments the cylindrical surface 206 when the placement member 200 is slidingly fitted to the pump body 100.

In certain examples, the outer surface 202 of the displacement member 200 may comprise an end face 204. In certain examples, the cavity 210 may be located in the end face 204 of the outer surface 202 of the displacement member 200. For instance, the example displacement member 200 shown in FIG. 3 comprises a cavity 210 comprising a truncated conical recess that is located in the end face 204 of the outer surface 202. The size of the conical recess may be determined by the minimum allowable thickness of the wall formed between the surface of the conical recess and the cylindrical surface 206.

In other examples, the cavity may be located in other positions in the portion of the outer surface 202 disposed in the chamber 102. For example, the cavity 210 may be located on this cylindrical surface 206.

In certain examples, where the cavity 210 takes the form of a conical recess or a cylindrical hole for example, the cavity 210 may be arranged coaxially with the cylindrical surface 206 so that the cavity 210 and the cylindrical surface 206 are substantially in alignment.

In certain examples, the outlet 108 may comprise a one-way outlet valve or outlet check valve. The one-way outlet valve may prevent fluid expelled from the chamber 102, by the motion of the displacement member 200, from returning to the chamber 102. For instance, when the displacement member 200 moves from the second position to the first position to increase the volume of the chamber 102, the one-way valve may be closed to prevent fluid being drawn back through the fluid outlet by the reduced pressure in the chamber 102. For example, the one-way outlet valve may comprise a biased ball or disc valve member that acts to close the fluid outlet when the volume of the chamber 102 is being increased. In another example, the one-way outlet valve may comprise a diaphragm valve member. The one-way valve may be closed by the suction action of the reducing pressure in the chamber 102 is the displacement member 200 pulls back.

The pump body 100 shown in FIG. 3 may comprise a single component or comprise a plurality of components. For example, the pump body 100 may comprise a pump chassis 110 onto which other components that define features of the pump body 100 are assembled. In certain examples, the chamber 102 may be defined by a sleeve 112 that fits into the pump chassis 110. In certain examples, where the displacement member 200 comprises a cylindrical surface 206, the sleeve 112 may define the cylindrical surface 102a to which the cylindrical surface 206 that slidingly mates.

In some examples, the sleeve 112 may comprise a seal groove 114 into which a seal, such as a resilient O-ring for example, may be mounted to seal between the chamber 102 and the displacement member 200. In such instances, the seal may be considered to be in a fixed position relative to the pump body 100. In other examples, the displacement member 200 may comprise a piston ring groove into which a piston ring may be mounted to seal between the chamber and the displacement member 200. In these other examples. the seal may be considered fixed relative to the displacement member 200.

In certain examples, the outlet 108 of the pump body 100 may comprise an outlet valve block 120. The outlet valve block 120 may be mounted to the pump chassis 110. For example, the outlet valve block 120 may have a generally cylindrical shape and be received in a complementarity shaped hole in the pump chassis 110. In certain examples, the outlet valve block 120 may comprise a mounting feature 124 to which a one-way outlet valve, such as the one-way valve described above, may be mounted.

The outlet valve block 120 may define an outlet passage 122 through which fluid may be expelled from the chamber 102 by the motion of the space of the displacement member 200. In certain examples, where the displacement pump 10 is used in a printing system 1, the outlet passage 122 may fluidly connect the chamber 102 with a fluid conduit that leads to the depositing system 20.

Although not shown in FIG. 3, the inlet 104 of the pump body 100 may, in certain examples, comprise an inlet valve block. The inlet valve vault may be mounted on the pump chassis 110. In some examples, the inlet 104 of the pump body 100 may comprise a one-way inlet valve that prevents fluid that has been admitted to the chamber 102 from travelling back into the inlet 104 from the chamber 102. In certain examples, the inlet 104 of the pump body 100 may not be provided with a valve.

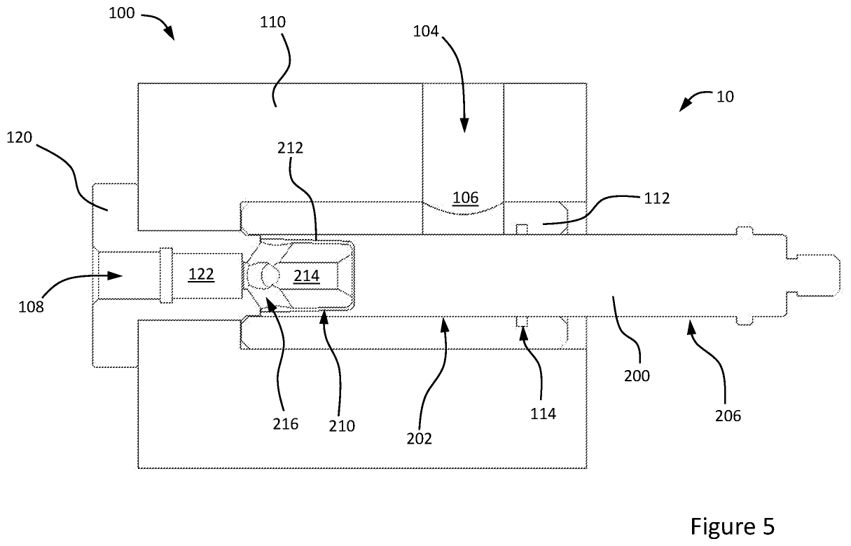

FIGS. 4 and 5 serve to illustrate another example of a displacement pump 10. FIG. 4 shows a perspective view of a cross section through the displacement pump 10 example. FIG. 5 shows a cross-section of the displacement pump 10 example of FIG. 4. The displacement pump 10 may comprise similar features to the displacement pump 10 described with respect to FIG. 3; similar features are indicated with like-numbered reference signs. The displacement pump 10 may be used to move a fluid. For example, the fluid may be a printing fluid. The displacement pump 10 of FIGS. 4 and 5 may, for example, be used in the printing system 1 shown in FIG. 1 to move printing fluid from the reservoir 30 to the depositing system 20.

In certain examples, the displacement pump 10 may comprise a plug 212. In certain examples, such as the displacement pump 10 shown in FIGS. 4 and 5, the pump body 100 may comprise a plug 212 The plug 212 may be located in the chamber 102. The plug 212 may be, at least partially, receivable within the cavity 210 of the displacement member 200. For example, the plug 212 may be at least partially received in the cavity 210 when the displacement member 200 is in the second position, relative to the pump body 100. For example, plug 212 may be, at least partially, receivable within the cavity 210 of the displacement member 200 during movement of the displacement member 200 to close the inlet 104.

In certain examples, the plug may be fixed to, or formed with, the pump body 100. In some examples, the plug may be fixed to, or formed with, the pump chassis 110. In some examples, the plug 212 may be fixed to, or formed with, the sleeve 112. In some examples, the plug 212 may be fixed to, or formed with, the outlet valve block 120. In the example shown in FIGS. 4 and 5, the plug 212 is formed with the outlet valve block 120.

As can be seen from FIGS. 4 and 5, the plug 212 may protrude into the volume of the chamber 112. The plug 212 acts to clear out the cavity 210 when the displacement member 200 reaches the end of its displacement stroke. In other words, as the displacement member 200 approaches the second position the plug 212 enters the cavity 210 and forces out any fluid located in the cavity 210. In the case of relatively high viscosity fluids, for example such as some printing fluids as described above, the plug prevents the relatively high viscosity fluid from remaining in the cavity 212 thereby reducing the effectiveness of the cavity 210 in providing an additional volume to accommodate fluid when the inlet 104 is open to the chamber 102.

In certain examples, the plug 212 may be aligned with the cavity 210 of the displacement member 200 so that, as the displacement member 200 moves to reduce the volume of the chamber 102, the plug 212 may easily enter, without interference, into the cavity at the end of the displacement stroke of the displacement member 200. For example, the plug 212 may be coaxially aligned with the cavity 210 of the displacement member 200.

In certain examples, the plug 212 may be shaped to complement the shape of the cavity 210. For example, the plug may be shaped to cooperatively mate with the cavity 210 at, or near, the end of the displacement stroke of the displacement member 200. In other words, the plug 212 and the cavity 210 may be shaped to fit together.

In certain examples, the plug 212 may comprise a tapered end that fits into the cavity 210. In the example displacement pump 10 shown in FIGS. 4 and 5, the plug 212 has a truncated conical shape that complements and fits the truncated conical recess located in the end face 204 of the displacement member 200. The truncated conical recess located in the end face 204 of the displacement member 200 and the conically shaped plug 212 may both be said to be drafted with respect to the direction of movement of the displacement member 200 so that the cavity 210 and the plug 212 can mate together without jamming. In other words, in some examples, the conical shape of the cavity 210 and of the plug 212 each have an angled surface, with respect to the direction of movement of the displacement member 200, such that the cavity 210 and the plug 212 do not meet until the displacement member 200 reaches the end position.

In certain examples, the plug 212 may comprise a plug fluid passage 214 to fluidly connect the chamber 102 with the fluid outlet. For example, the plug fluid passage 214 may be in fluid communication with the outlet passage 122 through the outlet valve block 120. In the example plug 212 shown in FIGS. 4 and 5, the plug fluid passage 214 may be aligned with the direction of movement of displacement member 200. For example, the plug passage 214 may comprise a drainage hole through the middle of the plug 212.

In certain examples, the plug 212 may comprise one or more drainage channels 216 that aid the flow of fluid through and/or around the plug 212 to the outlet 108 from the chamber 102. The drainage channels 216 may be arranged transversely with respect to an axis of the plug passage 214 that is aligned with the direction of movement of the displacement member 200. In an example, the drainage channels 216 may be substantially perpendicular to the direction of movement of the displacement member 200. In an example, as shown in FIGS. 4 and 5, the drainage channels 216 may be arranged at an angle to the direction of movement of the displacement member 200. In an example, as shown in FIGS. 4 and 5, four radially extending drainage channels 216 may be equally spaced around the base of the plug 212. The drainage channels 216 help to guide the fluid through and/or around the plug 212 to the outlet 108.

In an example, the displacement pump 10 may comprise a cylinder. For example, the pump body 100 may comprise the cylinder. The fluid inlet may be connected to the cylinder. The fluid outlet may be connected to the cylinder.

In certain examples, the displacement member 200 may comprise a plunger reciprocally movable within the cylinder. The plunger may comprise the cavity 210 located in a fluid driving surface of the plunger. In certain examples, the displacement member 200 may comprise a piston reciprocally movable within the cylinder. The piston may comprise the cavity 210 located in a fluid driving surface of the piston.

In certain examples, a plug, such as the plug 212, which is to be receivable within the cavity 210, may be located in the cylinder.

The plunger may be movable, in use, from a first position, in which the fluid inlet is open to allow a fluid to flow into the cylinder, to a second position, where the fluid inlet is closed by the plunger and the plug is at least partially received within the cavity, to force fluid in the cylinder through the fluid outlet.

The piston may be movable, in use, from a first position, in which the fluid inlet is open to allow a fluid to flow into the cylinder, to a second position, where the fluid inlet is closed by the piston and the plug is at least partially received within the cavity, to force fluid in the cylinder through the fluid outlet.

The operation of a displacement pump 10, such as any of the example displacement pumps 10 described above, will now be briefly described. From the displacement member 200 being located in the first, or starting, position, a fluid may be admitted into the chamber 102 of the pump body 100 through the inlet 104. The displacement member 200 may be moved to reduce the volume of the chamber 102. A portion of the fluid admitted to the chamber 102 may flow into the cavity 210, which is located in the portion of the displacement member 200 outer surface 202 that is disposed in the chamber 102. The displacement member 200 may be moved from the first position to the second, or end, position to force the fluid in the chamber through the outlet 108. Moving the displacement member 200 from the first position to the second position may shut the inlet 104 to the chamber 102. The movement of the displacement member 200 from the first position to the second position may be considered the displacement stroke of the displacement pump 10.

The displacement member 200 may be moved to increase the volume of the chamber 102. The displacement member 200 may be moved from the second position to the first position. Moving the displacement member from the second position to the first position may open the inlet 104 to the chamber 102. The movement of the displacement member from the second position to the first position may be considered the intake stroke of the displacement pump 10.

The displacement member 200 may be moved repeatedly from the first position to the second position and back to the first position in a reciprocating manner to receive and dispense a plurality of fluid volumes through the outlet 108. In certain examples, the displacement pump 10 may be used to receive a plurality of printing fluid volumes from the reservoir 30 and dispense those printing fluid volumes to the depositing system 20.

The operation(s) described above may be performed in the example printing system 1 described above and shown in FIG. 1. In certain examples, the printing system 1 may comprise one or more controllers 500. The controller(s) 500 may control the displacement pump 10 and/or the depositing system 20 and/or the reservoir 30. The controller(s) may comprise a computer. The controller 20 may control other features of the printing system 1 not described herein. In some examples, the controller(s) may be remotely connected to the printing system 10 over a network.

The controller 500 may comprise a processor. The processor may carry out any of the processes or operations described herein or instruct they be carried out in the printing system 1. The controller 20 may comprise a storage module. The storage module may comprise a non-transitory storage medium. The non-transitory machine-readable storage medium may be encoded with instructions executable by the processor. Any of the example processes or operations described herein may be encoded in machine readable form on the non-transitory storage medium. For example, the non-transitory machine-readable storage medium may be encoded with instructions for performing all, or any of, the operations described herein. For example, the processor may retrieve and execute the encoded instructions and perform any of the operations described herein or instruct another device, such as the displacement pump 10, to perform any of the operations described herein. The processor may execute the instructions may be carried out in any suitable order, or simultaneously. The processor may retrieve and execute encoded instructions and perform additional operations relating to other functions of the printing system.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A printing system comprising:
a depositing system to deposit printing fluid on a print medium;
a reservoir; and
a displacement pump to move printing fluid to the depositing system from the reservoir, the displacement pump comprising:
a pump body defining a chamber, an inlet to fluidly connect the chamber to the reservoir, and an outlet to fluidly connect the chamber to the depositing system;
a displacement member movable relative to the pump body, the displacement member having an outer surface and comprising a cavity located in a portion of the outer surface disposed in the chamber; and
wherein, in use, the displacement member is movable to close the inlet and to force printing fluid in the chamber through the outlet to the depositing system.

2. A printing system according to claim 1, wherein the displacement pump comprises a plug, wherein the plug is, at least partially, receivable within the cavity of the displacement member during movement of the displacement member to close the inlet.

3. A printing system according to claim 2, wherein the plug is located in the chamber.

4. A printing system according to claim 2, wherein the plug is shaped to complement the shape of the cavity of the displacement member.

5. A printing system according to claim 4, wherein the plug is shaped to cooperatively mate with the cavity.

6. A printing system according to claim 2, wherein the plug comprises a plug fluid passage to fluidly connect the chamber with the outlet.

7. A printing system according to claim 2, wherein the plug comprises one or more drainage channels to aid the flow of fluid through and/or around the plug to the outlet from the chamber.

8. A printing system according to claim 1, wherein the cavity is located in an end face of the displacement member.

9. A printing system according to claim 1, wherein the cavity comprises a conical recess in the outer surface of the displacement member.

10. A printing system according to claim 1, wherein the outlet comprises a one-way outlet valve to prevent fluid returning to the chamber through the outlet.

11. A displacement pump comprising:
a pump body defining a chamber, the chamber having a volume;
a displacement member having an outer surface, wherein at least a portion of the outer surface is disposed in the chamber;
a fluid outlet in fluid communication with the chamber;
wherein the displacement member is movable, in use, relative to the pump body to reduce the volume of the chamber, to force fluid in the chamber through the fluid outlet; and
wherein the displacement member comprises a conical recess in the portion of the outer surface disposed in the chamber.

12. A displacement pump according to claim 10, wherein the conical recess is located in an end face of the displacement member.

13. A displacement pump according to claim 10, wherein the displacement pump comprises a plug, wherein the plug is, at least partially, receivable within the conical recess.

14. A displacement pump according to claim 13, wherein the conical recess truncated conical recess and wherein the plug has a truncated conical shape that complements and fits the conical recess.

15. A printing system pump comprising:
a cylinder;
a fluid inlet connected to the cylinder;
a fluid outlet connected to the cylinder;
a plunger reciprocally movable within the cylinder, the plunger comprising a cavity in a fluid driving surface of the plunger;
a plug located in the cylinder, the plug to be receivable within the cavity; and
wherein the plunger is movable, in use, from a first position, in which the fluid inlet is open to allow a fluid to flow into the cylinder, to a second position, where the fluid inlet is closed by the plunger and the plug is at least partially received within the cavity, to force fluid in the cylinder through the fluid outlet.
